(19) United States
(12) Patent Application Publication
(10) Pub. No.: US 2026/0131770 A1
(43) Pub. Date: May 14, 2026

(54) VEHICLE DRIVING ASSISTANCE SYSTEM

(71) Applicant: TOYOTA JIDOSHA KABUSHIKI KAISHA, Aichi (JP)

(72) Inventors: Hikaru AKIMOTO, Mishima-shi (JP); Yasunobu YOKOI, Toyota-shi (JP)

(21) Appl. No.: 19/347,723

(22) Filed: Oct. 2, 2025

(30) Foreign Application Priority Data
Nov. 11, 2024 (JP) 2024-196615

(51) Int. Cl. B60T 7/22; B60Q 9/00; B60T 8/171; B60T 8/58; G08G 1/01; G08G 1/052; G08G 1/16

(52) U.S. Cl. CPC B60T 7/22; B60Q 9/008; B60T 8/171; B60T 8/58; G08G 1/012; G08G 1/0141; G08G 1/052; G08G 1/164; G08G 1/166; B60T 2201/022; B60T 2210/32

(57) ABSTRACT

A server of a vehicle driving assistance system receives position information wirelessly transmitted from a wireless communication terminal possessed by a moving object via a communication network, and transmits determination information to the vehicle driving assistance apparatus via the communication network when the server determines that a passing condition is satisfied based on the position information. A vehicle driving assistance apparatus of the vehicle driving assistance system performs a notification in a first notification manner to inform an operator of a host vehicle of the presence of a target moving object when a notification condition is satisfied, and performs the notification in a second notification manner different from the first notification manner when a target detection condition is satisfied while the notification is performed in the first notification manner.

### CROSS-REFERENCE TO RELATED APPLICATIONS

This application claims priority to Japanese patent application No. JP 2024-196615 filed on Nov. 11, 2024, the content of which is hereby incorporated by reference in its entirety.

### BACKGROUND

### Field

The present invention relates to a vehicle driving assistance system.

### Description of the Related Art

There is known a vehicle driving assistance system that performs a notification to notify an operator of a host vehicle of the presence of a moving object moving toward an intersection ahead of the host vehicle. As such a vehicle driving assistance system, there is also known a vehicle driving assistance system that provides, via a network server, the host vehicle with wireless communication information transmitted from a wireless communication terminal of the moving object, and performs the notification based on the provided wireless communication information (see, for example, Japanese Unexamined Patent Application Publication No. 2022-123691).

In the above-described vehicle driving assistance system, if wireless communication information is communicated constantly, the communication cost and communication load become large.

### SUMMARY

An object of the present invention is to provide a vehicle driving assistance system with low communication cost and communication load.

According to the present invention, a vehicle driving assistance system includes a vehicle driving assistance apparatus mounted on a host vehicle and a server provided on a communication network. The server is configured to receive position information wirelessly transmitted from a wireless communication terminal possessed by a moving object via the communication network, and transmit determination information to the vehicle driving assistance apparatus via the communication network when the server determines that a passing condition is satisfied based on the position information. The passing condition is a condition that the moving object passes at least one predetermined point toward a predetermined intersection. The at least one predetermined point is a point set on a predetermined cross road and located away from the predetermined intersection by a predetermined distance along the predetermined cross road. The predetermined cross road is a road intersecting with another road at the predetermined intersection. The determination information is information indicating that the moving object passes the at least one predetermined point on the predetermined cross road toward the predetermined intersection. The vehicle driving assistance apparatus is configured to perform a notification in a first notification manner to inform an operator of the host vehicle of the presence of a target moving object when a notification condition is satisfied. The notification condition is a condition that the predetermined intersection indicated by the received determination information is a target intersection and the predetermined cross road indicated by the received determination information is a target cross road. The vehicle driving assistance apparatus is configured to perform the notification in a second notification manner different from the first notification manner when a target detection condition is satisfied while the notification is performed in the first notification manner. The target detection condition is a condition that the target moving object is directly detected by an in-vehicle device of the host vehicle. The target intersection is an intersection located ahead in a traveling direction of the host vehicle. The target cross road is a road intersecting with a traveling road of the host vehicle at the target intersection. The target moving object is a moving object moving toward the target intersection along the target cross road.

If communication between the server and the vehicle driving assistance apparatus is constantly performed, communication cost and communication load increase. According to the vehicle driving assistance system of the present invention, when the server receives the position information from the wireless communication terminal and the passing condition is satisfied, the server transmits the determination information to the vehicle driving assistance apparatus. Further, according to the vehicle driving assistance system of the present invention, when the vehicle driving assistance apparatus receives the determination information from the server and the notification condition is satisfied, the vehicle driving assistance apparatus performs the notification. Therefore, according to the vehicle driving assistance system, it is possible to reduce the communication cost and the communication load.

In the vehicle driving assistance system according to an aspect of the present invention, the passing condition may be a condition that the moving object passes the at least one predetermined point toward the predetermined intersection and a moving speed of the moving object is a speed within a predetermined speed range.

According to the vehicle driving assistance system of this aspect of the present invention, it is possible to determine whether to transmit the determination information to the vehicle driving assistance apparatus in accordance with the moving speed of the moving object.

In the vehicle driving assistance system according to another aspect of the present invention, the at least one predetermined point may be a point set such that a moving object arrival time is longer than a delay time. The moving object arrival time may be a time required for the moving object to reach the predetermined intersection after reaching the at least one predetermined point. The delay time may be a time required from wireless transmission of the position information from the wireless communication terminal until the determination information is received by the vehicle driving assistance apparatus via the server.

According to the vehicle driving assistance system of this aspect of the present invention, even when the delay time occurs, the operator of the host vehicle can be appropriately notified of the presence of the target moving object.

In the vehicle driving assistance system according to further another aspect of the present invention, the notification condition may be a condition that the predetermined intersection indicated by the received determination information is the target intersection, the predetermined cross road indicated by the received determination information is the target cross road, and a host vehicle arrival time is a time within a predetermined notification time range. The host vehicle arrival time may be a time required from the reception of the determination information until the host vehicle reaches the target intersection. The predetermined notification time range may be a range from two seconds to five seconds.

When the operator of the host vehicle is notified of the presence of the target moving object is notified at a timing immediately before the host vehicle reaches the target intersection, it may be too late for the operator of the host vehicle to take an action to avoid a collision between the host vehicle and the target moving object. On the other hand, when the operator of the host vehicle is notified of the presence of the target moving object at a timing considerably earlier than when the host vehicle reaches the target intersection, it may be too early for the operator of the host vehicle to take an action to avoid a collision between the host vehicle and the target moving object.

According to the vehicle driving assistance system of this aspect of the present invention, when the timing at which the determination information is received is a timing from two seconds to five seconds before the host vehicle reaches the target intersection, the operator of the host vehicle is notified of the presence of the target moving object. Therefore, the operator of the host vehicle can be appropriately notified of the presence of the target moving object.

In the vehicle driving assistance system according to further another aspect of the present invention, the vehicle driving assistance apparatus may be configured to acquire a time until the host vehicle collides with the target moving object as a predicted time-to-collision, and start an automatic braking control to decelerate and stop the host vehicle when the predicted time-to-collision becomes equal to or shorter than a predetermined braking start time. The notification condition may be a condition that the predetermined intersection indicated by the received determination information is the target intersection, the predetermined cross road indicated by the received determination information is the target cross road, and a host vehicle arrival time is a time within a predetermined notification time range. The host vehicle arrival time may be a time required from the reception of the determination information until the host vehicle reaches the target intersection. The predetermined notification time range may be a range longer than the predetermined braking start time and equal to or shorter than a predetermined response start time. The predetermined response start time may be the maximum predicted time required for the operator of the host vehicle to start an action to avoid a collision between the target moving object and the host vehicle, and is predicted when the notification in the first notification manner is started.

In a case where the vehicle driving assistance apparatus is configured to execute the automatic braking control, when the operator of the host vehicle is notified of the presence of the target moving object at a timing immediately before the host vehicle reaches the target intersection, the automatic braking control may have already been started. On the other hand, when the operator of the host vehicle is notified of the presence of the target moving object at a timing considerably earlier than when the host vehicle reaches the target intersection, it may be too early for the operator of the host vehicle to take an action to avoid a collision between the host vehicle and the target moving object.

According to the vehicle driving assistance system of this aspect of the present invention, when the host vehicle arrival time at the point of receiving the determination information does not reach the predetermined braking start time and is equal to or shorter than the predetermined response start time, the operator of the host vehicle is notified of the presence of the target moving object. Therefore, the operator of the host vehicle can be appropriately notified of the presence of the target moving object.

In the vehicle driving assistance system according to further another aspect of the present invention, the at least one predetermined point may include a first point and a second point. The first point may be a point where the predetermined distance is a first distance. The second point may be a point where the predetermined distance is a second distance longer than the first distance. The passing condition may be a condition that the moving object passes the first point toward the predetermined intersection and a moving speed of the moving object is a speed within a first speed range, or that the moving object passes the second point toward the predetermined intersection and the moving speed of the moving object is a speed within a second speed range. A lower limit of the second speed range may be greater than an upper limit of the first speed range.

According to the vehicle driving assistance system of this aspect of the present invention, it is possible to determine whether to transmit the determination information to the vehicle driving assistance apparatus in accordance with the moving speed of the moving object.

In the vehicle driving assistance system according to further another aspect of the present invention, the speed within the first speed range may be a moving speed normally achieved by a pedestrian moving toward the predetermined intersection. The speed within the second speed range may be a moving speed normally achieved by a bicycle moving toward the predetermined intersection.

According to the vehicle driving assistance system of this aspect of the present invention, it is possible to determine whether to transmit the determination information to the vehicle driving assistance apparatus in accordance with whether the moving object is a pedestrian or a bicycle.

In the vehicle driving assistance system according to further another aspect of the present invention, the at least one predetermined point may include a first point, a second point, and a third point. The first point may be a point where the predetermined distance is a first distance. The second point may be a point where the predetermined distance is a second distance longer than the first distance. The third point may be a point where the predetermined distance is a third distance longer than the second distance. The passing condition may be a condition that the moving object passes the first point toward the predetermined intersection and a moving speed of the moving object is a speed within a first speed range, or that the moving object passes the second point toward the predetermined intersection and the moving speed of the moving object is a speed within a second speed range, or that the moving object passes the third point toward the predetermined intersection and the moving speed of the moving object is a speed within a third speed range. A lower limit of the second speed range may be greater than an upper limit of the first speed range. A lower limit of the third speed range may be greater than an upper limit of the second speed range.

According to the vehicle driving assistance system of this aspect of the present invention, it is possible to determine whether to transmit the determination information to the vehicle driving assistance apparatus in accordance with the moving speed of the moving object.

In the vehicle driving assistance system according to further another aspect of the present invention, the speed within the first speed range may be a moving speed normally achieved by a pedestrian moving toward the predetermined intersection. The speed within the second speed range may be a moving speed normally achieved by a bicycle moving toward the predetermined intersection. The speed within the third speed range may be a moving speed normally achieved by a motorcycle or an automobile moving toward the predetermined intersection.

According to the vehicle driving assistance system of this aspect of the present invention, it is possible to determine whether to transmit the determination information to the vehicle driving assistance apparatus in accordance with whether the moving object is a pedestrian, a bicycle, or a motorcycle or an automobile.

In the vehicle driving assistance system according to further another aspect of the present invention, the in-vehicle device may be an image sensor or an electromagnetic wave sensor.

According to the vehicle driving assistance system of this aspect of the present invention, the operator of the host vehicle can be notified of the presence of the target moving object detected using the image sensor or the electromagnetic wave sensor.

Elements of the present invention are not limited to elements of embodiments and modified examples of the present invention described with reference to the drawings. The other objects, features and accompanied advantages of the present invention can be easily understood from the embodiments and the modified examples of the present invention.

### BRIEF DESCRIPTION OF THE DRAWINGS

FIG. 1 is a diagram showing a vehicle driving assistance system according to an embodiment of the present invention.

FIG. 2 is a diagram showing a moving object, an intersection, and a host vehicle.

FIG. 3 is a diagram showing a vehicle driving assistance apparatus according to the embodiment of the present invention.

FIG. 4 is a flowchart showing a routine executed by a wireless communication terminal according to the embodiment of the present invention.

FIG. 5 is a flowchart showing a routine executed by a server according to the embodiment of the present invention.

FIG. 6 is a flowchart showing a routine executed by a vehicle driving assistance apparatus according to the embodiment of the present invention.

FIG. 7 is a diagram showing a predetermined point.

FIG. 8 is a diagram showing a first point, a second point, and a third point.

FIG. 9 is a diagram showing a target intersection.

FIG. 10 is a diagram showing a target crossing point.

FIG. 11 is a diagram showing a target moving object image.

### DETAILED DESCRIPTION

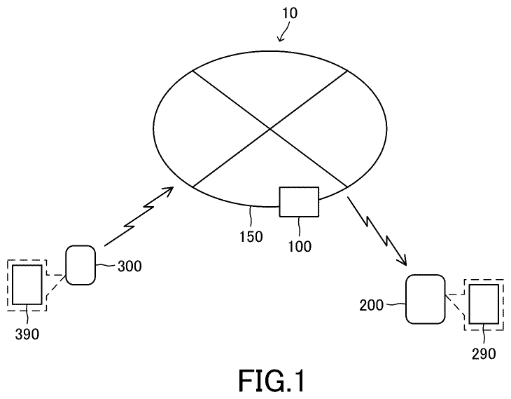

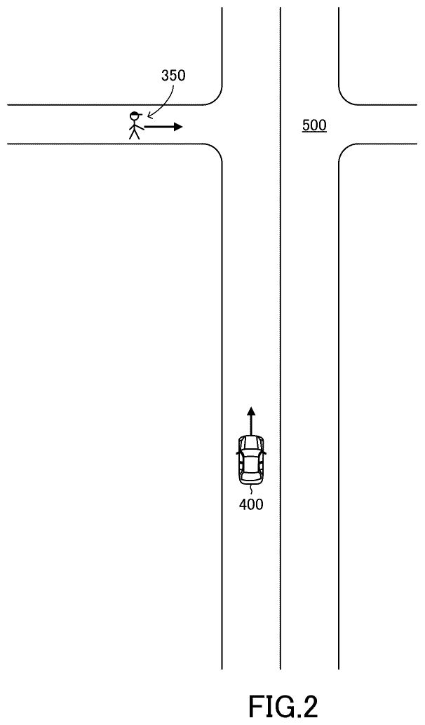

Hereinafter, a vehicle driving assistance system according to an embodiment of the present invention will be described with reference to the drawings. FIG. 1 shows the vehicle driving assistance system 10 according to the embodiment of the present invention. As shown in FIG. 2, the vehicle driving assistance system 10 notifies an operator of a host vehicle 400 of the presence of a moving object 350 entering an intersection 500 in front of the host vehicle 400. It should be noted that, in this example, the moving object 350 includes a pedestrian, a bicycle, a motorcycle, and an automobile.

The vehicle driving assistance system 10 includes a server 100 and a vehicle driving assistance apparatus 200.

As shown in FIG. 1, the server 100 is provided on a communication network 150. The server 100 receives position information IPO via the communication network 150. In this example, the position information IPO is wireless communication information IW transmitted wirelessly from a wireless communication terminal 300. The position information IPO is information indicating the position of the wireless communication terminal 300. In this example, the wireless communication terminal 300 is possessed by the moving object 350. Therefore, the position information IPO is also information indicating the position of the moving object 350 possessing the wireless communication terminal 300. Further, in this example, the position information IPO is information indicating the position of the wireless communication terminal 300 in terms of latitude and longitude.

Further, when a predetermined condition is satisfied, the server 100 transmits information about the moving object 350 to the vehicle driving assistance apparatus 200 via the communication network 150.

The wireless communication terminal 300 has a wireless communication function. The wireless communication terminal 300 is, for example, a so-called mobile phone.

The wireless communication terminal 300 includes an ECU (electronic control unit) 390. The ECU 390 includes a microcomputer as a main component. The microcomputer includes a CPU, a computer-readable storage medium, and an interface. The storage medium includes ROM, RAM, and non-volatile memory. The CPU is configured to realize various functions by executing instructions, programs, or routines stored in the storage medium. In particular, in this example, the wireless communication terminal 300 stores programs in the storage medium for realizing various controls executed by the wireless communication terminal 300.

The wireless communication terminal 300 transmits the position information IPO to the outside of the wireless communication terminal 300 when a predetermined condition is satisfied. As described above, the position information IPO is information indicating the position of the wireless communication terminal 300. The wireless communication terminal 300 recognizes its position using its GPS function.

It should be noted that, in this example, the exchange of wireless communication information between the wireless communication terminal 300, the server 100, and the vehicle driving assistance apparatus 200 utilizes so-called V2N technology. Therefore, in this example, the communication network 150 is an internet communication network, which is a part of a communication infrastructure (facility) used in V2N technology. However, the present invention is also applicable in cases where a communication infrastructure including a communication network used in a so-called V2X technology including V2N technology is utilized.

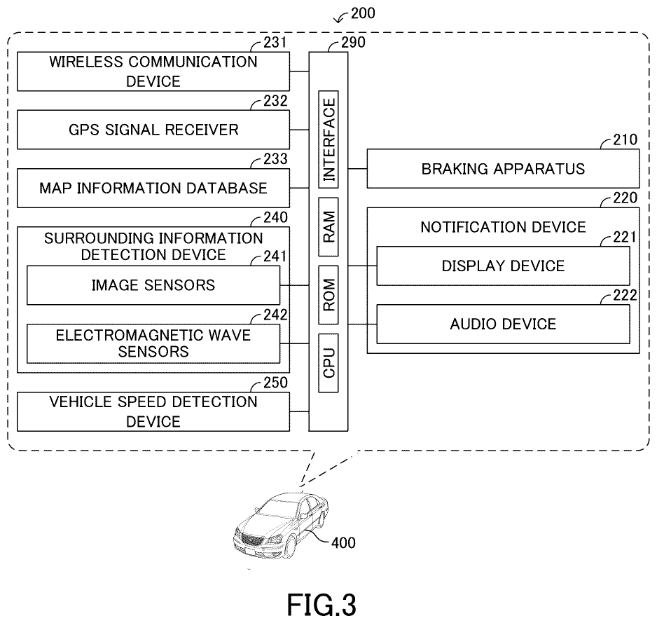

As shown in FIG. 3, the vehicle driving assistance apparatus 200 is mounted in the host vehicle 400. Hereinafter, the vehicle driving assistance apparatus 200 will be described by taking as an example a case where an operator of the host vehicle 400 is a driver of the host vehicle 400 (that is, a person who gets into the host vehicle 400 and drives the host vehicle 400).

However, the operator of the host vehicle 400 may be a remote operator of the host vehicle 400 (that is, a person who drives the host vehicle 400 remotely without getting in the host vehicle 400). In a case where the operator of the host vehicle 400 is a remote operator, the vehicle driving assistance apparatus 200 is mounted in both the host vehicle 400 and a remote operation equipment. The remote operation equipment is installed outside the host vehicle 400 for remotely operating the host vehicle 400. In this case, the functions of the vehicle driving assistance apparatus 200 described below are shared between the vehicle driving assistance apparatus 200 mounted in the host vehicle 400 and the vehicle driving assistance apparatus 200 mounted in the remote operation equipment.

As shown in FIG. 3, the vehicle driving assistance apparatus 200 includes an ECU (electronic control unit) 290 as a control device. The ECU 290 includes a microcomputer as a main component. The microcomputer includes a CPU, a computer-readable storage medium, and an interface. The storage medium includes ROM, RAM, and non-volatile memory. The CPU is configured to realize various functions by executing instructions, programs, or routines stored in the storage medium. In particular, in this example, the vehicle driving assistance apparatus 200 stores programs in the storage medium for realizing various controls executed by the vehicle driving assistance apparatus 200.

It should be noted that, in this example, the vehicle driving assistance apparatus 200 includes only one ECU 290, but it may include a plurality of ECUs, and the functions of the vehicle driving assistance apparatus 200 described below may be shared among the respective ECUs.

Further, the vehicle driving assistance apparatus 200 may be configured to update programs stored in the storage medium via wireless communication (for example, internet communication) with external devices.

It should be noted that the vehicle driving assistance apparatus 200 is applicable not only to a vehicle driven manually by the operator but also to a vehicle driven automatically.

The host vehicle 400 is equipped with a braking apparatus 210 and a notification device 220.

The braking apparatus 210 applies braking force to the host vehicle 400. The braking apparatus 210 is, for example, a hydraulic brake apparatus. The braking apparatus 210 is electrically connected to the ECU 290. The vehicle driving assistance apparatus 200 applies braking force to the host vehicle 400 by controlling the operation of the braking apparatus 210.

The notification device 220 provides various notifications to the driver of the host vehicle 400. The notification device 220 includes a display device 221 and an audio device 222.

The display device 221 displays various images. The display device 221 includes, for example, a display. The display device 221 is electrically connected to the ECU 290. The vehicle driving assistance apparatus 200 displays various images using the display device 221.

The audio device 222 outputs various sounds and/or voices. The audio device 222 includes, for example, a speaker. The audio device 222 is electrically connected to the ECU 290. The vehicle driving assistance apparatus 200 outputs various sounds and/or voices using the audio device 222.

Further, the host vehicle 400 is equipped, as in-vehicle devices, with a wireless communication device 231, a GPS signal receiver 232, a map information database 233, a surrounding information detection device 240, and a vehicle speed detection device 250.

The wireless communication device 231 receives information about the moving object 350. The information about the moving object 350 is information transmitted from the server 100 via the communication network 150. The wireless communication device 231 is electrically connected to the ECU 290. The vehicle driving assistance apparatus 200 receives information about the moving object 350 via the wireless communication device 231.

The GPS signal receiver 232 receives so-called GPS signals. The GPS signal receiver 232 is electrically connected to the ECU 290. The vehicle driving assistance apparatus 200 receives GPS signals via the GPS signal receiver 232. The vehicle driving assistance apparatus 200 acquires the current position PE of the host vehicle 400 based on the GPS signals.

The map information database 233 stores map information. The map information database 233 is electrically connected to the ECU 290. The vehicle driving assistance apparatus 200 acquires map information IM from the map information database 233 based on the current position PE of the host vehicle 400. The map information IM is map information about the surroundings of the host vehicle 400.

The surrounding information detection device 240 detects information about the surroundings of the host vehicle 400. The surrounding information detection device 240 includes a plurality of image sensors 241 and a plurality of electromagnetic wave sensors 242.

The image sensor 241 captures images of the surroundings of the host vehicle 400. The image sensor 241 is, for example, a camera sensor. The image sensors 241 are electrically connected to the ECU 290. The vehicle driving assistance apparatus 200 acquires image data or image information about the surroundings of the host vehicle 400 using the image sensors 241 as surrounding information IS.

The electromagnetic wave sensor 242 acquires information about objects around the host vehicle 400. The electromagnetic wave sensor 242 is, for example, a millimeter-wave radar. The electromagnetic wave sensors 242 are electrically connected to the ECU 290. The vehicle driving assistance apparatus 200 acquires object data or object information about objects around the host vehicle 400 using the electromagnetic wave sensors 242 as surrounding information IS.

The vehicle speed detection device 250 detects the traveling speed of the host vehicle 400. The vehicle speed detection device 250 includes, for example, wheel rotation speed sensors provided on respective wheels of the host vehicle 400. The vehicle speed detection device 250 is electrically connected to the ECU 290. The vehicle driving assistance apparatus 200 acquires the traveling speed of the host vehicle 400 as a host vehicle speed VE using the vehicle speed detection device 250.

### Operation of Vehicle Driving Assistance System

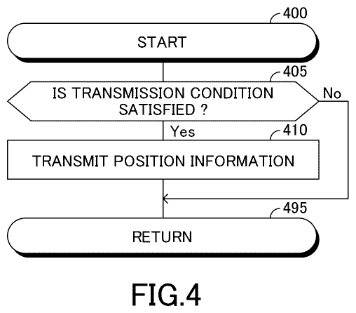

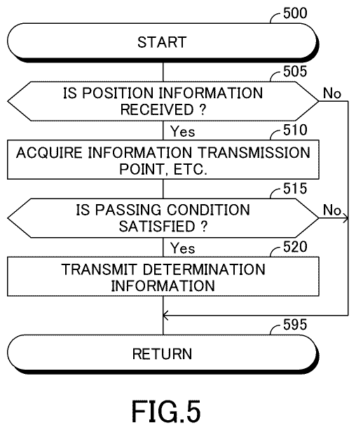

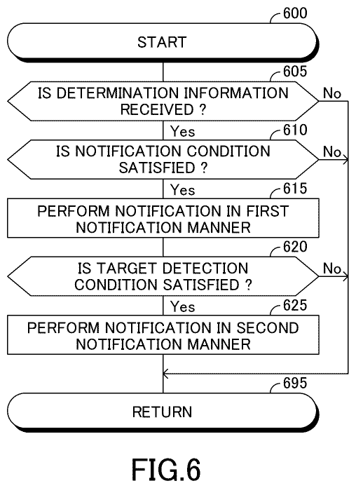

Next, the operation of the vehicle driving assistance system 10 will be described. The wireless communication terminal 300 is configured to execute the routine shown in FIG. 4 at predetermined time intervals. The server 100 is configured to execute the routine shown in FIG. 5 at predetermined time intervals. Further, the vehicle driving assistance apparatus 200 is configured to execute the routine shown in FIG. 6 at predetermined time intervals. Accordingly, when a predetermined condition is satisfied, the vehicle driving assistance apparatus 200 performs a notification described later.

The wireless communication terminal 300 starts the process from a step S400 of the routine shown in FIG. 4 at a predetermined timing and proceeds with the process to a step S405 to determine whether a transmission condition C1 is satisfied.

The transmission condition C1 is a condition that the wireless communication terminal 300 reaches a pre-passing point Pa or a post-passing point Pc. In other words, the transmission condition C1 is a condition that the moving object 350 possessing the wireless communication terminal 300 reaches a pre-passing point Pa or a post-passing point Pc.

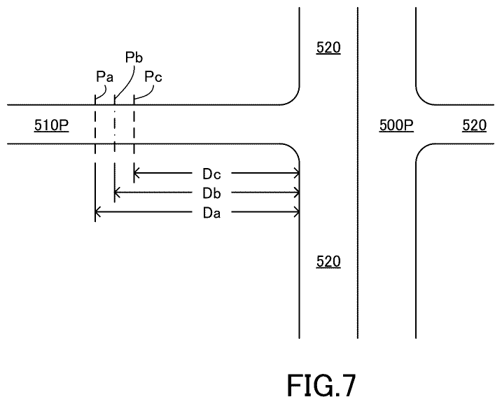

As shown in FIG. 7, the pre-passing point Pa is a point set on a predetermined cross road 510P and located away from a predetermined point Pb in one direction along the predetermined cross road 510P by a pre-passing distance Da. The one direction is a direction away from a predetermined intersection 500P. On the other hand, the post-passing point Pc is a point set on the predetermined cross road 510P and located away from the predetermined point Pb in the other direction along the predetermined cross road 510P by a post-passing distance Dc. The other direction is a direction approaching the predetermined intersection 500P.

The predetermined cross road 510P is a road that intersects with another road 520 at the predetermined intersection 500P.

The predetermined point Pb is a point set on the predetermined cross road 510P and located away from the predetermined intersection 500P by a predetermined distance Db along the predetermined cross road 510P.

The predetermined distance Db is a distance set such that a moving object arrival time TM is longer than a delay time TD. That is, the predetermined point Pb is a point set such that the moving object arrival time TM is longer than the delay time TD.

The moving object arrival time TM is a time required for the wireless communication terminal 300 to reach the predetermined intersection 500P after reaching the predetermined point Pb. In other words, the moving object arrival time TM is a time required for the moving object 350 possessing the wireless communication terminal 300 to reach the predetermined intersection 500P after reaching the predetermined point Pb.

The delay time TD is a time required from when the position information IPO is wirelessly transmitted from the wireless communication terminal 300 until the vehicle driving assistance apparatus 200 receives determination information ID described later via the server 100.

The pre-passing distance Da and the post-passing distance Dc may be the same or different. However, the pre-passing distance Da and the post-passing distance Dc are set to distances suitable for the server 100 to determine that the moving object 350 passes the predetermined point Pb on the predetermined cross road 510P, as described later.

It should be noted that, as described above, the wireless communication terminal 300 recognizes its current position using its GPS function. The wireless communication terminal 300 determines whether it reaches the pre-passing point Pa or the post-passing point Pc based on its current position recognized using its GPS function.

Alternatively, the transmission condition C1 may be a condition that the wireless communication terminal 300 reaches a first pre-passing point Pa1, a first post-passing point Pc1, a second pre-passing point Pa2, a second post-passing point Pc2, a third pre-passing point Pa3, or a third post-passing point Pc3. In other words, the transmission condition C1 may be a condition that the moving object 350 possessing the wireless communication terminal 300 reaches the first pre-passing point Pa1, the first post-passing point Pc1, the second pre-passing point Pa2, the second post-passing point Pc2, the third pre-passing point Pa3, or the third post-passing point Pc3.

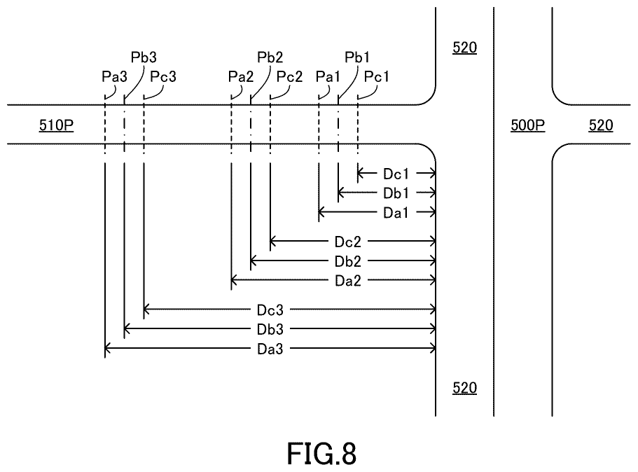

As shown in FIG. 8, the first pre-passing point Pa1 is a point set on the predetermined cross road 510P and located away from a first point Pb1 in one direction along the predetermined cross road 510P by a first pre-passing distance Da1. The one direction is a direction away from the predetermined intersection 500P. The first post-passing point Pc1 is a point set on the predetermined cross road 510P and located away from the first point Pb1 in the other direction along the predetermined cross road 510P by a first post-passing distance Dc1. The other direction is a direction approaching the predetermined intersection 500P.

The first point Pb1 is a point set on the predetermined cross road 510P and located away from the predetermined intersection 500P by a first distance Db1 along the predetermined cross road 510P. The first distance Db1 is a distance set such that the moving object arrival time TM of the moving object 350 having a moving speed within a first speed range R1 is longer than the delay time TD. That is, the first point Pb1 is a point set such that the moving object arrival time TM of the moving object 350 having a moving speed within the first speed range R1 is longer than the delay time TD.

The speed within the first speed range R1 is a moving speed normally achieved by a pedestrian moving toward the predetermined intersection 500P.

The first pre-passing distance Da1 and the first post-passing distance Dc1 may be the same or different. However, the first pre-passing distance Da1 and the first post-passing distance Dc1 are set to distances suitable for the server 100 to determine that the moving object 350 having a moving speed within the first speed range R1 passes the first point Pb1 on the predetermined cross road 510P, as described later.

Similarly, as shown in FIG. 8, the second pre-passing point Pa2 is a point set on the predetermined cross road 510P and located away from a second point Pb2 in one direction along the predetermined cross road 510P by a second pre-passing distance Da2. The one direction is a direction away from the predetermined intersection 500P. The second post-passing point Pc2 is a point set on the predetermined cross road 510P and located away from the second point Pb2 in the other direction along the predetermined cross road 510P by a second post-passing distance Dc2. The other direction is a direction approaching the predetermined intersection 500P.

The second point Pb2 is a point set on the predetermined cross road 510P and located away from the predetermined intersection 500P by a second distance Db2 along the predetermined cross road 510P. The second distance Db2 is a distance set such that the moving object arrival time TM of the moving object 350 having a moving speed within a second speed range R2 is longer than the delay time TD. That is, the second point Pb2 is a point set such that the moving object arrival time TM of the moving object 350 having a moving speed within the second speed range R2 is longer than the delay time TD.

The speed within the second speed range R2 is a moving speed normally achieved by a bicycle moving toward the predetermined intersection 500P. It should be noted that the lower limit of the second speed range R2 is greater than the upper limit of the first speed range R1. Therefore, the second distance Db2 is longer than the first distance Db1.

The second pre-passing distance Da2 and the second post-passing distance Dc2 may be the same or different. However, the second pre-passing distance Da2 and the second post-passing distance Dc2 are set to distances suitable for the server 100 to determine that the moving object 350 having a moving speed within the second speed range R2 passes the second point Pb2 on the predetermined cross road 510P, as described later.

Similarly, as shown in FIG. 8, the third pre-passing point Pa3 is a point set on the predetermined cross road 510P and located away from a third point Pb3 in one direction along the predetermined cross road 510P by a third pre-passing distance Da3. The one direction is a direction away from the predetermined intersection 500P. The third post-passing point Pc3 is a point set on the predetermined cross road 510P and located away from the third point Pb3 in the other direction along the predetermined cross road 510P by a third post-passing distance Dc3. The other direction is a direction approaching the predetermined intersection 500P.

The third point Pb3 is a point set on the predetermined cross road 510P and located away from the predetermined intersection 500P by a third distance Db3 along the predetermined cross road 510P. The third distance Db3 is a distance set such that the moving object arrival time TM of the moving object 350 having a moving speed within a third speed range R3 is longer than the delay time TD. That is, the third point Pb3 is a point set such that the moving object arrival time TM of the moving object 350 having a moving speed within the third speed range R3 is longer than the delay time TD.

The speed within the third speed range R3 is a moving speed normally achieved by a motorcycle or an automobile moving toward the predetermined intersection 500P. It should be noted that the lower limit of the third speed range R3 is greater than the upper limit of the second speed range R2. Therefore, the third distance Db3 is longer than the second distance Db2.

The third pre-passing distance Da3 and the third post-passing distance Dc3 may be the same or different. However, the third pre-passing distance Da3 and the third post-passing distance Dc3 are set to distances suitable for the server 100 to determine that the moving object 350 having a moving speed within the third speed range R3 passes the third point Pb3 on the predetermined cross road 510P, as described later.

It should be noted that, as described above, the wireless communication terminal 300 recognizes its current position using its GPS function. The wireless communication terminal 300 determines whether it reaches the first pre-passing point Pa1, the first post-passing point Pc1, the second pre-passing point Pa2, the second post-passing point Pc2, the third pre-passing point Pa3, or the third post-passing point Pc3 based on its current position recognized using its GPS function.

When the wireless communication terminal 300 determines “Yes” at the step S405, it proceeds with the process to a step S410 to transmit the position information IPO wirelessly to the outside of the wireless communication terminal 300. Next, the wireless communication terminal 300 proceeds with the process to a step S495 to terminate the process of this routine once.

On the other hand, when the wireless communication terminal 300 determines “No” at the step S405, it proceeds with the process directly to the step S495 to terminate the process of this routine once.

Furthermore, the server 100 starts the process from a step S500 of the routine shown in FIG. 5 at a predetermined timing and proceeds with the process to a step S505 to determine whether it receives the position information IPO transmitted wirelessly from the wireless communication terminal 300.

When the server 100 determines “Yes” at the step S505, it proceeds with the process to a step S510 to acquire transmission information ITR based on the received position information IPO. The transmission information ITR indicates an information transmission point PT of the wireless communication terminal 300, a moving speed VW of the wireless communication terminal 300, and a moving direction DIR of the wireless communication terminal 300.

The information transmission point PT is a point at which the position information IPO is transmitted from the wireless communication terminal 300. Therefore, the information transmission point PT is also the position of the moving object 350 possessing the wireless communication terminal 300 at the time of transmission of the position information IPO.

The moving speed VW of the wireless communication terminal 300 is the speed at which the wireless communication terminal 300 moves. Therefore, the moving speed VW of the wireless communication terminal 300 is also the moving speed of the moving object 350 possessing the wireless communication terminal 300.

The moving direction DIR of the wireless communication terminal 300 is the direction in which the wireless communication terminal 300 moves. Therefore, the moving direction DIR of the wireless communication terminal 300 is also the moving direction of the moving object 350 possessing the wireless communication terminal 300.

Next, the server 100 proceeds with the process to a step S515 to determine whether a passing condition C2 is satisfied based on the information transmission point PT, the moving speed VW, and the moving direction DIR of the wireless communication terminal 300 acquired at the step S510.

The passing condition C2 is a condition that the wireless communication terminal 300 passes the predetermined point Pb toward the predetermined intersection 500P. In other words, the passing condition C2 is a condition that the moving object 350 possessing the wireless communication terminal 300 passes the predetermined point Pb toward the predetermined intersection 500P.

In particular, in this example, the passing condition C2 is a condition that the wireless communication terminal 300 which transmits the position information IPO passes the predetermined point Pb on the predetermined cross road 510P toward the predetermined intersection 500P. In other words, the passing condition C2 is a condition that the moving object 350 possessing the wireless communication terminal 300 which transmits the position information IPO passes the predetermined point Pb on the predetermined cross road 510P toward the predetermined intersection 500P.

Alternatively, the passing condition C2 may be a condition that the wireless communication terminal 300 which transmits the position information IPO passes the predetermined point Pb on the predetermined cross road 510P toward the predetermined intersection 500P and the moving speed VW of the wireless communication terminal 300 is within a predetermined speed range R0. That is, the passing condition C2 may be a condition that the moving object 350 possessing the wireless communication terminal 300 which transmits the position information IPO passes the predetermined point Pb on the predetermined cross road 510P toward the predetermined intersection 500P and the moving speed VM of the moving object 350 is within the predetermined speed range R0.

The predetermined speed range R0 is a range having, as the lower limit, the minimum value of the moving speeds normally achieved by pedestrians, bicycles, motorcycles, and automobiles moving toward the predetermined intersection 500P, and as the upper limit, the maximum value thereof.

Alternatively, the passing condition C2 may be a condition that any one of a first condition C21 to a third condition C23 is satisfied.

The first condition C21 is a condition that the wireless communication terminal 300 which transmits the position information IPO passes the first point Pb1 on the predetermined cross road 510P toward the predetermined intersection 500P and the moving speed VW of the wireless communication terminal 300 is within the first speed range R1. In other words, the first condition C21 is a condition that the moving object 350 possessing the wireless communication terminal 300 which transmits the position information IPO passes the first point Pb1 on the predetermined cross road 510P toward the predetermined intersection 500P and the moving speed of the moving object 350 is within the first speed range R1.

As described above, the speed within the first speed range R1 is a moving speed normally achieved by a pedestrian moving toward the predetermined intersection 500P.

The second condition C22 is a condition that the wireless communication terminal 300 which transmits the position information IPO passes the second point Pb2 on the predetermined cross road 510P toward the predetermined intersection 500P and the moving speed VW of the wireless communication terminal 300 is within the second speed range R2. In other words, the second condition C22 is a condition that the moving object 350 possessing the wireless communication terminal 300 which transmits the position information IPO passes the second point Pb2 on the predetermined cross road 510P toward the predetermined intersection 500P and the moving speed of the moving object 350 is within the second speed range R2.

As described above, the speed within the second speed range R2 is a moving speed normally achieved by a bicycle moving toward the predetermined intersection 500P. It should be noted that the lower limit of the second speed range R2 is greater than the upper limit of the first speed range R1.

The third condition C23 is a condition that the wireless communication terminal 300 which transmits the position information IPO passes the third point Pb3 on the predetermined cross road 510P toward the predetermined intersection 500P and the moving speed VW of the wireless communication terminal 300 is within the third speed range R3. In other words, the third condition C23 is a condition that the moving object 350 possessing the wireless communication terminal 300 which transmits the position information IPO passes the third point Pb3 on the predetermined cross road 510P toward the predetermined intersection 500P and the moving speed of the moving object 350 is within the third speed range R3.

As described above, the speed within the third speed range R3 is a moving speed normally achieved by a motorcycle or an automobile moving toward the predetermined intersection 500P. It should be noted that the lower limit of the third speed range R3 is greater than the upper limit of the second speed range R2.

When the server 100 determines “Yes” at the step S515, it proceeds with the process to a step S520 to transmit the determination information ID to the vehicle driving assistance apparatus 200 via the communication network 150. That is, when the server 100 determines that the passing condition C2 is satisfied based on the position information IPO, it transmits the determination information ID to the vehicle driving assistance apparatus 200 via the communication network 150. Next, the server 100 proceeds with the process to a step S595 to terminate the process of this routine once.

In this example, the determination information ID includes passing information IPA and type information ITY.

The passing information IPA is information indicating that the wireless communication terminal 300 passes the predetermined point Pb on the predetermined cross road 510P toward the predetermined intersection 500P. In other words, the passing information IPA is also information indicating that the moving object 350 possessing the wireless communication terminal 300 which transmits the position information IPO passes the predetermined point Pb on the predetermined cross road 510P toward the predetermined intersection 500P.

The type information ITY is information indicating the type of the moving object 350 possessing the wireless communication terminal 300 which transmits the position information IPO. As described above, in this example, the moving object 350 includes a pedestrian, a bicycle, a motorcycle, and an automobile. Therefore, the type information ITY is information indicating that the moving object 350 is a pedestrian, the moving object 350 is a bicycle, or the moving object 350 is a motorcycle or an automobile.

The server 100 determines, based on the moving speed VW of the wireless communication terminal 300, whether the moving object 350 possessing the wireless communication terminal 300 is a pedestrian, a bicycle, or a motorcycle or an automobile. Specifically, when the moving speed VW of the wireless communication terminal 300 is within the first speed range R1, the server 100 determines that the moving object 350 possessing the wireless communication terminal 300 is a pedestrian. When the moving speed VW of the wireless communication terminal 300 is within the second speed range R2, the server 100 determines that the moving object 350 is a bicycle. When the moving speed VW is within the third speed range R3, the server 100 determines that the moving object 350 is a motorcycle or an automobile.

On the other hand, when the server 100 determines “No” at the step S505 or at the step S515, it proceeds with the process directly to the step S595 to terminate the process of this routine once.

The vehicle driving assistance apparatus 200 starts the process from a step S600 of the routine shown in FIG. 6 at a predetermined timing and proceeds with the process to a step S605 to determine whether it receives the determination information ID transmitted from the server 100.

When the vehicle driving assistance apparatus 200 determines “Yes” at the step S605, it proceeds with the process to a step S610 to determine whether a notification condition C3 is satisfied.

In this example, the notification condition C3 is a condition that the predetermined intersection 500P indicated by the received determination information ID is a target intersection 500T and the predetermined cross road 510P indicated by the received determination information ID is a target cross road 510T.

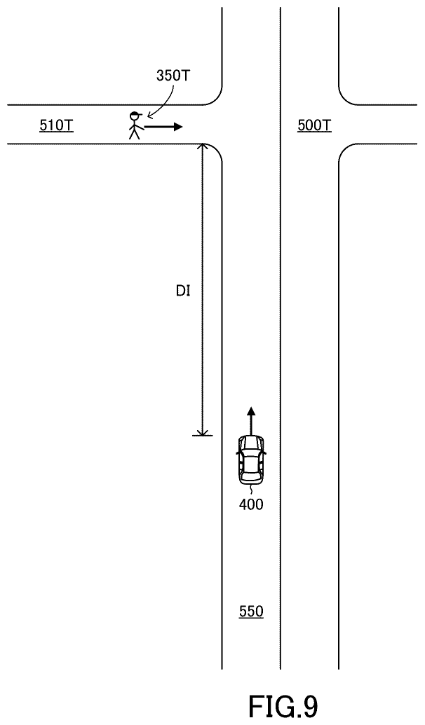

As shown in FIG. 9, the target intersection 500T is an intersection located ahead in the traveling direction of the host vehicle 400. In particular, in this example, the target intersection 500T is an intersection located ahead in the traveling direction of the host vehicle 400 and existing within a predetermined distance (intersection determination distance DI) from the host vehicle 400.

The target cross road 510T is a road that intersects with a traveling road 550 of the host vehicle 400 at the target intersection 500T.

Alternatively, the notification condition C3 may be a condition that the predetermined intersection 500P indicated by the received determination information ID is the target intersection 500T, the predetermined cross road 510P indicated by the received determination information ID is the target cross road 510 T, and a host vehicle arrival time TE is within a predetermined notification time range RT. Here, the host vehicle arrival time TE is a time required from the reception of the determination information ID until the host vehicle 400 reaches the target intersection 500T. The predetermined notification time range RT is a range from two seconds to five seconds.

Alternatively, in a case where the vehicle driving assistance apparatus 200 is configured to execute an automatic braking control, the notification condition C3 may be as follows. More specifically, in a case where the vehicle driving assistance apparatus 200 acquires a predicted time-to-collision TTC and starts an automatic braking control to decelerate and stop the host vehicle 400 when the predicted time-to-collision TTC becomes equal to or shorter than a predetermined braking start time TTC_BK, the notification condition C3 may be as follows.

That is, in this case, the notification condition C3 may be a condition that the predetermined intersection 500P indicated by the received determination information ID is the target intersection 500T, the predetermined cross road 510P indicated by the received determination information ID is the target cross road 510T, and the host vehicle arrival time TE is within the predetermined notification time range RT.

It should be noted that the predicted time-to-collision TTC is a time until the host vehicle 400 collides with the target moving object 350T. More specifically, the predicted time-to-collision TTC is a time required for the host vehicle 400 to reach a target crossing point PC when it is determined that the host vehicle 400 may collide with the target moving object 350T, based on the host vehicle speed VE, a host vehicle collision distance DE, the moving speed VM of the target moving object 350T, and a moving object collision distance DM. Therefore, the predicted time-to-collision TTC is a time obtained by dividing the host vehicle collision distance DE by the host vehicle speed VE when it is determined that the host vehicle 400 may collide with the target moving object 350T.

As shown in FIG. 9, the target moving object 350T is a moving object moving toward the target intersection 500T along the target cross road 510T.

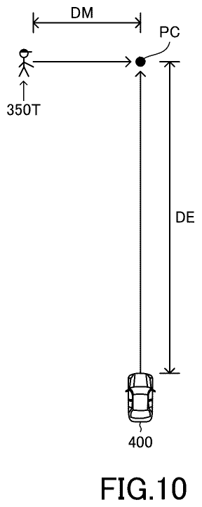

As shown in FIG. 10, the host vehicle collision distance DE is a distance from the host vehicle 400 to the target crossing point PC. The moving object collision distance DM is a distance from the target moving object 350T to the target crossing point PC. The target crossing point PC is a point where the predicted traveling route of the host vehicle 400 and the predicted moving route of the target moving object 350T intersect.

As described above, the host vehicle arrival time TE is a time required from the reception of the determination information ID until the host vehicle 400 reaches the target intersection 500T.

The predetermined notification time range RT is a range that is longer than the predetermined braking start time TTC_BK and equal to or shorter than a predetermined response start time TR. Here, the predetermined response start time TR is the maximum predicted time required for the driver of the host vehicle 400 to start an action to avoid a collision between the target moving object 350T and the host vehicle 400, and is predicted when the notification in a first notification manner described later is started.

When the vehicle driving assistance apparatus 200 determines “Yes” at the step S610, it proceeds with the process to a step S615 to perform a notification in the first notification manner to inform the driver of the host vehicle 400 of the presence of the target moving object 350T. That is, when the notification condition C3 that the predetermined intersection 500P indicated by the received determination information ID is the target intersection 500T and the predetermined cross road 510P indicated by the received determination information ID is the target cross road 510T is satisfied, the vehicle driving assistance apparatus 200 performs the notification in the first notification manner to inform the operator of the host vehicle 400 of the presence of the target moving object 350T.

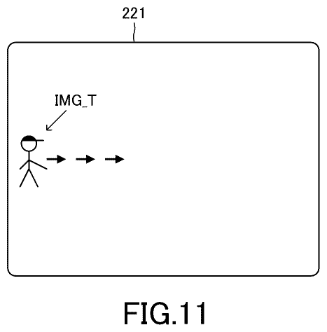

In this example, the notification in the first notification manner is performed in a predetermined manner by the notification device 220. For example, as shown in FIG. 11, the notification in the first notification manner is performed by displaying a target moving object image IMG_T in a predetermined form by the display device 221. Alternatively, in addition to or in place of this, the notification in the first notification manner is performed by outputting a sound of a predetermined pattern from the audio device 222. Alternatively, in addition to this or in place of this, the notification in the first notification manner is performed by outputting a voice of predetermined content from the audio device 222.

It should be noted that the target moving object image IMG_T is an image representing the target moving object 350T. In particular, when the determination target moving object 350D is a pedestrian, the target moving object image IMG_T is an image representing a pedestrian. When the determination target moving object 350D is a bicycle, the target moving object image IMG_T is an image representing a bicycle. When the determination target moving object 350D is a motorcycle or an automobile, the target moving object image IMG_T is an image representing a motorcycle and/or an automobile.

The determination target moving object 350D is a moving object indicated by the determination information ID.

In this example, the notification in the first notification manner is continued until the target moving object 350T enters the target intersection 500T. Alternatively, the notification in the first notification manner is continued for a predetermined time TP.

Next, the vehicle driving assistance apparatus 200 proceeds with the process to a step S620 to determine whether a target detection condition C4 is satisfied.

In this example, the target detection condition C4 is a condition that the target moving object 350T is detected based on the surrounding information IS.

When the vehicle driving assistance apparatus 200 determines “Yes” at the step S620, it proceeds with the process to a step S625 to terminate the notification in the first notification manner and perform a notification in a second notification manner to inform the driver of the host vehicle 400 of the presence of the target moving object 350T. Next, the vehicle driving assistance apparatus 200 proceeds with the process to a step S695 to terminate the process of this routine once.

In this example, the notification in the second notification manner is performed in a predetermined manner by the notification device 220. However, the notification in the second notification manner is performed in a manner different from that of the notification in the first notification manner.

For example, the notification in the second notification manner is performed by displaying the target moving object image IMG_T in a form different from the predetermined form in the first notification manner by the display device 221. In this case, for example, in the notification in the second notification manner, the vehicle driving assistance apparatus 200 displays the target moving object image IMG_T in a size or color different from that in the first notification manner.

Alternatively, in addition to or in place of this, the notification in the second notification manner is performed by outputting a sound of a pattern different from the predetermined pattern in the first notification manner from the audio device 222. In this case, for example, when one short sound is output from the audio device 222 in the notification in the first notification manner, the vehicle driving assistance apparatus 200 outputs two short sounds consecutively in the notification in the second notification manner.

Alternatively, in addition to or in place of this, the notification in the second notification manner is performed by outputting a voice of content different from the predetermined content in the notification in the first notification manner from the audio device 222.

As described above, while the vehicle driving assistance apparatus 200 performs the notification in the first notification manner, when the target detection condition C4 that the vehicle driving assistance apparatus 200 directly detects the target moving object 350T by the in-vehicle equipment (in this example, the surrounding information detection device 240) of the host vehicle 400 is satisfied, the vehicle driving assistance apparatus 200 performs the notification in the second notification manner, which is different from the first notification manner.

On the other hand, when the vehicle driving assistance apparatus 200 determines “No” at the step S605, the step S610, or the step S620, it proceeds with the process directly to the step S695 to terminate the process of this routine once.

The above is the operation of the vehicle driving assistance system 10.

When communication is constantly performed between the wireless communication terminal 300, the server 100, and the vehicle driving assistance apparatus 200, the communication cost and the communication load increase. According to the vehicle driving assistance system 10, the wireless communication terminal 300 transmits the position information IPO when reaching a predetermined point (for example, the pre-passing point Pa and the post-passing point Pc). Also, according to the vehicle driving assistance system 10, when the server 100 receives the position information IPO from the wireless communication terminal 300, the server 100 transmits the determination information ID to the vehicle driving assistance apparatus 200 when the passing condition C2 is satisfied. Then, according to the vehicle driving assistance system 10, when the vehicle driving assistance apparatus 200 receives the determination information ID from the server 100, it performs the notification when the notification condition C3 is satisfied. Therefore, according to the vehicle driving assistance system 10, the communication cost and the communication load are reduced.

It should be noted that the present invention is not limited to the aforementioned embodiments, and various modifications can be employed within the scope of the invention.

What is claimed is:

1. A vehicle driving assistance system including a vehicle driving assistance apparatus mounted on a host vehicle and a server provided on a communication network,
wherein the server is configured to:
receive position information wirelessly transmitted from a wireless communication terminal possessed by a moving object via the communication network; and
transmit determination information to the vehicle driving assistance apparatus via the communication network when the server determines that a passing condition is satisfied based on the position information,
the passing condition is a condition that the moving object passes at least one predetermined point toward a predetermined intersection,
the at least one predetermined point is a point set on a predetermined cross road and located away from the predetermined intersection by a predetermined distance along the predetermined cross road,
the predetermined cross road is a road intersecting with another road at the predetermined intersection,
the determination information is information indicating that the moving object passes the at least one predetermined point on the predetermined cross road toward the predetermined intersection,
the vehicle driving assistance apparatus is configured to:
perform a notification in a first notification manner to inform an operator of the host vehicle of the presence of a target moving object when a notification condition is satisfied,
the notification condition being a condition that the predetermined intersection indicated by the received determination information is a target intersection and the predetermined cross road indicated by the received determination information is a target cross road; and
perform the notification in a second notification manner different from the first notification manner when a target detection condition is satisfied while the notification is performed in the first notification manner,
the target detection condition being a condition that the target moving object is directly detected by an in-vehicle device of the host vehicle,
the target intersection is an intersection located ahead in a traveling direction of the host vehicle,
the target cross road is a road intersecting with a traveling road of the host vehicle at the target intersection, and
the target moving object is a moving object moving toward the target intersection along the target cross road.

2. The vehicle driving assistance system according to claim 1, wherein the passing condition is a condition that the moving object passes the at least one predetermined point toward the predetermined intersection and a moving speed of the moving object is a speed within a predetermined speed range.

3. The vehicle driving assistance system according to claim 1,
wherein the at least one predetermined point is a point set such that a moving object arrival time is longer than a delay time,
the moving object arrival time is a time required for the moving object to reach the predetermined intersection after reaching the at least one predetermined point, and
the delay time is a time required from wireless transmission of the position information from the wireless communication terminal until the determination information is received by the vehicle driving assistance apparatus via the server.

4. The vehicle driving assistance system according to claim 1,
wherein the notification condition is a condition that the predetermined intersection indicated by the received determination information is the target intersection, the predetermined cross road indicated by the received determination information is the target cross road, and a host vehicle arrival time is a time within a predetermined notification time range,
the host vehicle arrival time is a time required from the reception of the determination information until the host vehicle reaches the target intersection, and
the predetermined notification time range is a range from two seconds to five seconds.

5. The vehicle driving assistance system according to claim 1,
wherein the vehicle driving assistance apparatus is configured to:
acquire a time until the host vehicle collides with the target moving object as a predicted time-to-collision; and
start an automatic braking control to decelerate and stop the host vehicle when the predicted time-to-collision becomes equal to or shorter than a predetermined braking start time,
the notification condition is a condition that the predetermined intersection indicated by the received determination information is the target intersection, the predetermined cross road indicated by the received determination information is the target cross road, and a host vehicle arrival time is a time within a predetermined notification time range,
the host vehicle arrival time is a time required from the reception of the determination information until the host vehicle reaches the target intersection,
the predetermined notification time range is a range longer than the predetermined braking start time and equal to or shorter than a predetermined response start time, and
the predetermined response start time is the maximum predicted time required for the operator of the host vehicle to start an action to avoid a collision between the target moving object and the host vehicle, and is predicted when the notification in the first notification manner is started.

6. The vehicle driving assistance system according to claim 1,
wherein the at least one predetermined point includes a first point and a second point,
the first point is a point where the predetermined distance is a first distance,
the second point is a point where the predetermined distance is a second distance longer than the first distance,
the passing condition is a condition that the moving object passes the first point toward the predetermined intersection and a moving speed of the moving object is a speed within a first speed range, or that the moving object passes the second point toward the predetermined intersection and the moving speed of the moving object is a speed within a second speed range, and
a lower limit of the second speed range is greater than an upper limit of the first speed range.

7. The vehicle driving assistance system according to claim 6,
wherein the speed within the first speed range is a moving speed normally achieved by a pedestrian moving toward the predetermined intersection, and
the speed within the second speed range is a moving speed normally achieved by a bicycle moving toward the predetermined intersection.

8. The vehicle driving assistance system according to claim 1,
wherein the at least one predetermined point includes a first point, a second point, and a third point,
the first point is a point where the predetermined distance is a first distance,
the second point is a point where the predetermined distance is a second distance longer than the first distance,
the third point is a point where the predetermined distance is a third distance longer than the second distance,
the passing condition is a condition that the moving object passes the first point toward the predetermined intersection and a moving speed of the moving object is a speed within a first speed range, or that the moving object passes the second point toward the predetermined intersection and the moving speed of the moving object is a speed within a second speed range, or that the moving object passes the third point toward the predetermined intersection and the moving speed of the moving object is a speed within a third speed range,
a lower limit of the second speed range is greater than an upper limit of the first speed range, and
a lower limit of the third speed range is greater than an upper limit of the second speed range.

9. The vehicle driving assistance system according to claim 8,
wherein the speed within the first speed range is a moving speed normally achieved by a pedestrian moving toward the predetermined intersection,
the speed within the second speed range is a moving speed normally achieved by a bicycle moving toward the predetermined intersection, and
the speed within the third speed range is a moving speed normally achieved by a motorcycle or an automobile moving toward the predetermined intersection.

10. The vehicle driving assistance system according to claim 1, wherein the in-vehicle device is an image sensor or an electromagnetic wave sensor.
